(19) United States
(12) Patent Application Publication
(10) Pub. No.: US 2017/0277346 A1
(43) Pub. Date: Sep. 28, 2017

(54) TOUCH DETECTION METHOD AND APPARATUS FOR PERFORMING CLUSTER-BASED TOUCH DETECTION

(71) Applicant: CRUCIALTEC CO., LTD, Asan-si (KR)

(72) Inventors: Ick Chan JEONG, Hwasseong-si (KR); Dong Woon KIM, Seoul (KR)

(21) Appl. No.: 15/504,833

(22) PCT Filed: Aug. 17, 2015
(86) PCT No.: PCT/KR2015/008556

§ 371 Date: Feb. 17, 2017

(30) Foreign Application Priority Data
Aug. 20, 2014 (KR) 10-2014-0108066

(51) Int. Cl. G06F 3/041; G06F 3/044

(52) U.S. Cl. CPC G06F 3/0416; G06F 3/044; G06F 2203/04108

(57) ABSTRACT

A touch detection apparatus includes: a touch panel including a plurality of sensing nodes; and a touch detection unit configured to perform a hover detection operation on a plurality of clusters in which each of the clusters is configured as any one of the plurality of sensing nodes and at least one sensing node adjacent thereto, and to detect whether a touch occurs on sensing nodes included in a specific cluster based on a result of the hover detection operation. A touch detection method includes: performing hover detection operation for each of a plurality of clusters, each cluster comprising any one of a plurality of sensing nodes and at least one sensing node adjacent thereto; and detecting the occurrence of touch for the sensing nodes in the corresponding cluster based on the result of the hover detection operation.

### CROSS-REFERENCE TO RELATED APPLICATIONS

This application is the National Stage Entry of International Patent Application No. PCT/KR2015/008556, filed on Aug. 17, 2015, and claims priority from and the benefit of Korean Patent Application No. 10-2014-0108066, filed on Aug. 20, 2014, each of which is incorporated by reference for all purposes as if fully set forth herein.

### BACKGROUND

Field

Exemplary embodiments of the present invention relate to a touch detection method and apparatus for performing cluster-based touch detection, and more particularly, to a touch detection method and apparatus capable of maintaining resolution while improving sensitivity in a touch detection operation.

Discussion of the Background

A touch screen panel is a device which inputs an instruction from a user by touching a letter or a feature displayed on a screen of an image display device with a human finger or another contact means. The touch screen panel is attached on the image display device and converts a touch position touched by the human finger into an electrical signal. The electrical signal is used as an input signal.

FIG. 1 is a diagram illustrating a configuration of a conventional touch detection apparatus.

Referring to FIG. 1, a touch detection apparatus may include a touch panel 10 and a driving device 20.

The touch panel 10 may include a plurality of sensing pads 11 arranged in rows and columns, and the driving device 20 may include a touch detection unit 21. Each of the sensor pads 11 and the driving device 20 may be connected through a signal line 12. The touch detection unit 21 may sequentially select one of a plurality of signal lines 12, and perform a touch detection operation on the sensor pad 11 connected to the corresponding signal line 12. Touch capacitance is generated between a touch generation means (for example, a human finger, etc.) and the sensor pad 11, and an amplitude of a signal output from the sensor pad 11 may be changed according to an amount of the touch capacitance. The touch detection unit 21 may detect whether a touch occurs on each of the sensor pads 11 based on the amplitude of the signal output from the selected sensor pad 11 after applying a predetermined voltage to the sensor pad 11.

As the amount of the touch capacitance generated between the sensor pad 11 and the touch generation means is great, a difference between output signals from the sensor pad 11 before and after a touch occurs is increased. That is, as the amount of the touch capacitance is great, sensitivity is increased when determining whether a touch occurs on the sensor pad 11.

The amount of the touch capacitance is increased by increasing amplitude of a voltage supplied to the sensor pad 11 in an operation of determining whether a touch occurs or increasing an area of the sensor pad 11. However, when increasing the amplitude of the voltage supplied to the sensor pad 11, power consumption is increased, and an influence of a parasitic capacitance present in a circuit is also increased. Further, when increasing the area of the sensor pad 11, the resolution of determining whether a touch occurs is decreased.

FIG. 2 is a diagram for describing another example of a conventional touch detection apparatus.

Referring to FIG. 2, a touch detection apparatus may include a touch panel 30 and a driving device 40. The touch panel 30 may include a plurality of driving electrodes 31 arranged in parallel, and a plurality of sensing electrodes 32 arranged perpendicular to an arrangement direction of the driving electrodes 31. The driving electrode 31 and the sensing electrode 32 may be formed on different layers, and may be electrically insulated.

A driving signal provider 41 of the driving device 40 may apply a predetermined driving signal to one driving electrode 31 selected from the plurality of driving electrodes 31, and the touch detection unit 42 may receive a signal output from the sensing electrode 32.

When the predetermined driving signal is applied to the driving electrode 31, mutual capacitance is generated between the driving electrode 31 and the sensing electrode 32, and a predetermined response signal is output from the sensing electrode 32 according to the mutual capacitance.

A region in which the driving electrode 31 and the sensing electrode 32 intersects may be referred to as a sensing node N, which is a touch detection unit, and a change occurs in the mutual capacitance generated between the driving electrode 31 and the sensing electrode 32 passing through the touched sensing node N when a touch occurs in the sensing node N, and thus a difference is generated in the response signal output from the sensing electrode 32.

The touch detection apparatus shown in FIG. 2 may determine whether a touch occurs on each sensing node N using the principle described above.

Here, in order to improve sensitivity, the mutual capacitance generated between the driving electrode 31 and the sensing electrode 32 and its amount of change should be increased. There are a method of increasing an amplitude of a predetermined driving signal and a method of increasing thicknesses of the driving electrode 31 and the sensing electrode 32 in order to increase a size of the sensing node N, but there are problems in which the power consumption is increased when the amplitude of the predetermined driving signal is increased and the resolution of detecting whether a touch has occurred is decreased when the size of the sensing node N is increased.

Accordingly, a touch detection apparatus capable of maintaining resolution while improving sensitivity in a touch detection operation is needed.

### SUMMARY

The present invention has an objective of solving problems of the conventional art.

The present invention is directed to providing a touch detection method and apparatus capable of maintaining resolution while improving sensitivity in a touch detection operation.

The present invention is also directed to providing a touch detection method and apparatus capable of improving efficiency of detecting a touch in a touch detection operation by performing the touch detection operation using maximum resolution only when a touch occurs.

The present invention is further directed to providing a touch detection method and apparatus capable of exactly distinguishing a non-contact type touch generation means and a contact type touch generation means and detecting whether a touch has occurred in a dead zone.

One aspect of the present invention provides a touch detection method, including: (a) performing a hover detection operation on each of a plurality of clusters in which each of the clusters is configured as any one of a plurality of sensing nodes and at least one sensing node adjacent thereto; and (b) detecting whether a touch occurs on sensing nodes included in a corresponding cluster based on a result of the hover detection operation.

Step (a) may include: performing the hover detection operation on each of the plurality of clusters in which the sensing nodes included in each of the plurality of clusters do not overlap; setting any one of the plurality of sensing nodes as a reference node, and designating the plurality of clusters in which each cluster is configured as the reference node and at least one sensing node adjacent to the reference node; and when the hover detection signal is detected in an arbitrary cluster, performing the hover detection operation on each of the clusters by designating the plurality of clusters so that each of the plurality of sensing nodes is used as the reference node once.

Step (b) may include performing the touch detection operation on each sensing node included in a cluster in which a hover generation signal is detected.

Step (b) may include performing the touch detection operation on each of the sensing nodes only when the hover generation signal has a threshold value or more.

When a touch generation signal is detected in a specific sensing node according to a result obtained by performing the touch detection operation, the touch detection method may further include determining that a touch occurs on the corresponding sensing node.

Step (a) may include obtaining an output signal of each of the clusters by simultaneously applying a predetermined driving signal to the plurality of sensing nodes configuring each of the clusters, and combining output signals from the sensing electrodes passing through the sensing nodes as a response to the predetermined driving signal.

Step (a) may include: simultaneously applying the predetermined driving signal to at least one driving electrode passing through the plurality of sensing nodes configuring each of the clusters; and obtaining an output signal of each of the clusters by combining output signals from at least one sensing electrode passing through the plurality of sensing nodes configuring each of the clusters.

Another aspect of the present invention provides a touch detection method, including: selecting a first cluster configured as a plurality of sensing nodes; obtaining a first output signal of the first cluster by combining output signals as a result of a touch detection operation performed on the sensing nodes included in the first cluster; selecting a second cluster including some of the sensing nodes of the first cluster and configured as a plurality of sensing nodes; and obtaining a second output signal of the second cluster.

The first cluster and the second cluster may respectively include a first reference node and a second reference node, and the touch detection apparatus may further include a memory configured to store the output signals of the first cluster and the second cluster in correspondence to the first reference node and the second reference node.

The first reference node and the second reference node may be arranged to be adjacent to each other.

Another aspect of the present invention provides a touch detection apparatus, including: a touch panel including a plurality of sensing nodes; and a touch detection unit configured to perform a hover detection operation on a plurality of clusters in which each of the clusters is configured as any one of the plurality of sensing nodes, one of sensing nodes in each cluster being set as a reference node, each of the clusters being configured as a reference node and at least one sensing node being adjacent to the reference node, and to detect whether a touch occurs on sensing nodes included in a specific cluster based on a result of the hover detection operation.

According to an exemplary embodiment of the present invention, since a touch detection operation is performed in units of clusters in which each cluster includes a plurality of sensing nodes, the sensitivity of the touch detection operation may be improved, and since all of the sensing nodes are used as the reference sensing node one by one, the resolution can be maintained to be the same as a case in which the touch detection operation is performed on each of the sensing nodes.

According to an exemplary embodiment of the present invention, efficiency of detecting whether a touch has occurred in the touch detection operation may be improved by the touch detection operation being performed by decreasing the resolution and performing the touch detection operation at maximum resolution only when a touch generation signal is detected.

According to an exemplary embodiment of the present invention, a non-contact type touch generation means and a contact type touch generation means can be exactly distinguished by performing the touch detection operation for each of sensing nodes included in a cluster determined as a touch generation position.

According to an exemplary embodiment of the present invention, since a touch detection operation is performed in units of clusters, a touch can also be detected in a dead zone.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIGS. 1 and 2 are drawings for describing a configuration of conventional touch detection apparatuses.

FIGS. 3A-3B are cross-sectional views for describing a configuration of a touch detection apparatus according to one exemplary embodiment of the present invention.

FIG. 4 is a drawing for describing a configuration of a touch detection apparatus according to one exemplary embodiment of the present invention.

FIGS. 5A-5E are diagrams for describing a touch detection method of the touch detection apparatus shown in FIG. 4.

FIG. 6 is a diagram for describing a configuration of a touch detection apparatus according to another exemplary embodiment of the present invention.

FIGS. 7A-7D are diagrams for describing a touch detection method of the touch detection apparatus shown in FIG. 6.

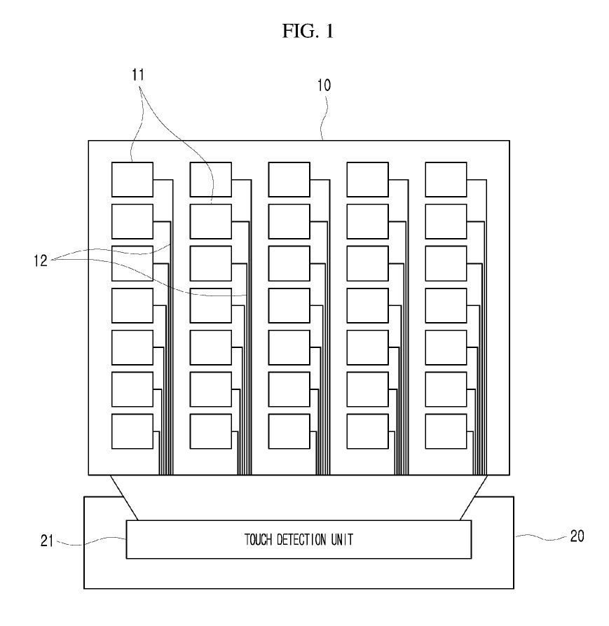

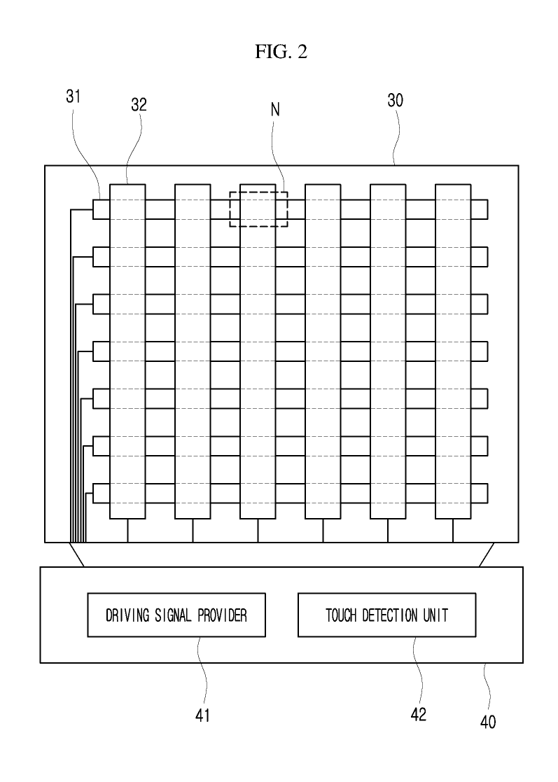

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. It should be understood that when an element is referred to as being “connected” or “coupled” to another element, the element can be directly connected or coupled to the other element or intervening elements may be present. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Hereinafter, the present invention will be described with reference to the accompanying drawings. The present invention may be implemented in various forms, and accordingly, is not limited to embodiments described herein. In order to clearly describe the present invention, a description of a portion which is not related to the present invention will be omitted, and like reference numerals represent like components throughout the specification.

Throughout the specification, it should be understood that when an element is referred to as being “connected” or “coupled” to another element, the element can be directly connected or coupled to the other element or intervening elements may be present. Further, it should be understood that the terms “comprises,” “comprising,” “includes,” and/or “including” do not preclude one or more other components when used herein and further include one or more components unless stated otherwise.

Hereinafter, exemplary embodiments of the present invention will be described in detail with reference to the accompanying drawings.

In this specification, the term “sensing node” may refer to the smallest unit of a touch detection target, include one sensor pad therein, and may be used a term that refers to a position at which two electrodes having different functions intersect.

When a touch detection apparatus of the present invention is driven using a self-capacitive method, each sensor pad may be arranged to be interlocked with a sensor pad adjacent thereto at an edge thereof, and in this case, a region in which the sensor pads are interlocked with each other and a central region in which each sensor pad is not interlocked with another sensor pad may be divided, and each of the regions may form a “sensing node”. That is, the “sensing node” may include only a portion of one sensor pad, and may include a region in which a plurality of sensor pads are arranged to be interlocked with each other.

When the touch detection apparatus of the present invention is driven using a mutual-capacitive method, a position at which two electrodes having different functions intersect may be defined as a “sensing node,” but a portion of a region in which two electrodes intersect each other or a set of a plurality of regions intersect each other may be defined as a “sensing node” according to an arrangement form of the two electrodes having different functions.

As described above, a “sensing node” is not limited by the touch detection method, and may be defined in various manners according to a shape of sensor pads or electrodes configuring the touch detection apparatus.

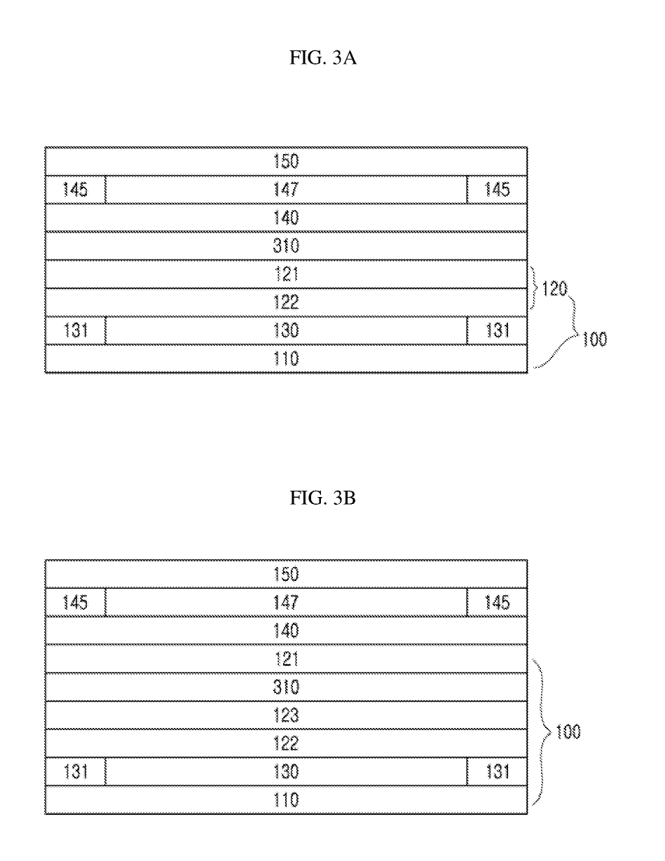

FIGS. 3A-3B are cross-sectional view diagrams for describing a configuration of a display device including a touch detection apparatus according to one exemplary embodiment of the present invention.

First, FIG. 3A illustrates an on-cell method of stacking a touch detection apparatus 310 on a display panel 100.

Referring to FIG. 3A, a thin film transistor array substrate 110 and a color filter array substrate 120 may be arranged to face each other, a liquid crystal layer 130 may be interposed between the thin film transistor array substrate 110 and the color filter array substrate 120, and the touch detection apparatus 310 may be stacked on the color filter array substrate 120. A polarizing film 140 may be stacked on the touch detection apparatus 310, and a window 150 serving as a cover of the display device may be attached to an upper surface of the polarizing film 140.

The thin film transistor array substrate 110 may include a plurality of gate lines (not shown) and data lines (not shown) defining a pixel region by intersecting each other on the substrate, pixel electrodes (not shown) formed on the pixel regions, and thin film transistors (not shown) formed at intersections of the gate lines and the data lines.

The color filter array substrate 120 may include a color filter layer 122 formed on the color filter substrate 121.

The thin film transistor array substrate 110 and the color filter array substrate 120 may be attached by being spaced apart from each other by a predetermined distance using a sealing material 131, and the liquid crystal layer 130 may be inserted into a space between the thin film transistor array substrate 110 and the color filter array substrate 120.

Meanwhile, the polarizing film 140 and the window 150 may be bonded to each other using an adhesive 145, and a predetermined space 147 may be formed between the polarizing film 140 and the window 150.

A touch means and the touch detection apparatus 310 may not be in direct contact with each other by the space 147 between the polarizing film 140 and the window 150, and an influence due to external noise may be decreased.

Next, FIG. 3B illustrates an in-cell method of forming the touch detection apparatus 310 in the display panel 100.

The in-cell method may be different from the on-cell method in a point in which the touch detection apparatus 310 is not attached to an upper surface of the color filter array substrate 120 but is inserted between the color filter substrate 121 and the color filter layer 122 in the color filter array substrate 120. An insulating layer 123 may be formed between the touch detection apparatus 310 and the color filter layer 122.

The in-cell method may have a smaller physical thickness than the on-cell method, and thus the display device may be slim.

Hereinafter, a configuration and an operation of the touch detection apparatus 310 according to the exemplary embodiment of the present invention will be described.

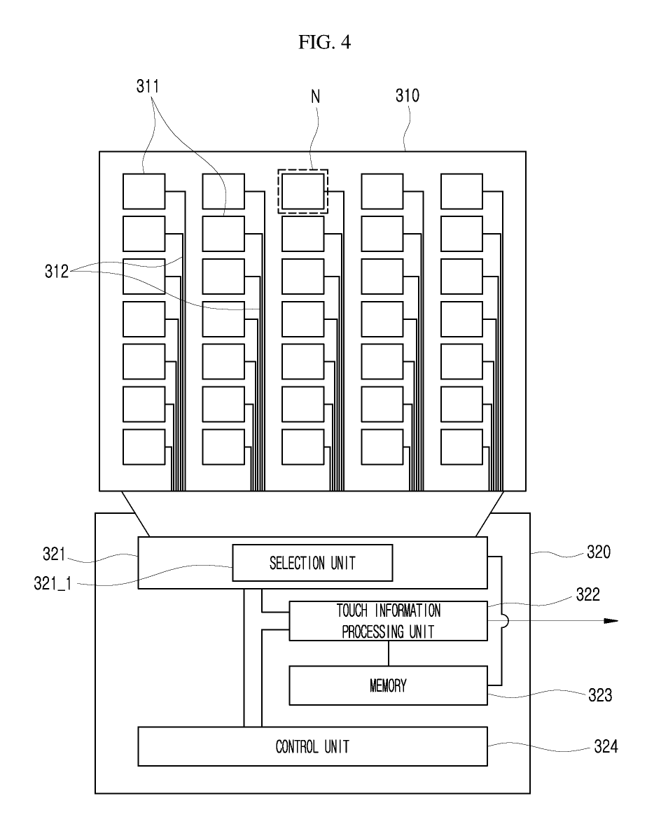

FIG. 4 is a diagram illustrating a configuration of a touch detection apparatus according to one exemplary embodiment of the present invention.

Referring to FIG. 4, the touch detection apparatus includes a touch panel 310 and a driving device 320.

The touch panel 310 may include a plurality of sensing nodes N. The sensing node N may be a minimum unit used for determining whether a touch has occurred. In the exemplary embodiment of FIG. 4, each of the sensing nodes N may be configured as one sensor pad 311. One signal line 312 may be connected to each of the sensor pads 311.

A plurality of sensor pads 311 may have a rectangle or a rhombus shape, have other shapes, and have a uniform polygonal shape. The sensor pads 311 may be arranged in a matrix form in which polygons are adjacent to each other.

The driving device 320 may include a touch detection unit 321, a touch information processing unit 322, a memory 323, and a control unit 324, and may be implemented as one or more integrated circuit (IC) chips.

The touch detection unit 321, the touch information processing unit 322, the memory 323, and the control unit 324 may be independently implemented, or two or more of the components may be integrally implemented.

The touch detection unit 321 may include a plurality of switches and a plurality of capacitors which are connected to the sensor pads 311 and the signal lines 312, drive circuits for detecting a touch by receiving a signal from the control unit 324, and output a voltage corresponding to a touch detection result.

The touch detection unit 321 according to one exemplary embodiment of the present invention may simultaneously select the plurality of sensing nodes N arranged to be adjacent to each other, that is, the sensor pads 311. The plurality of sensor pads 311 which are simultaneously selected may be referred to as a cluster. That is, a cluster may be a unit of selection regarding the plurality of sensor pads 311.

When one cluster is selected, a predetermined driving signal may be simultaneously applied to the sensor pads 311 included in the selected cluster, and the touch detection unit 321 may simultaneously receive a response signal according to the predetermined driving signal from corresponding sensor pads 311.

The touch detection unit 321 may include a selection unit 321_1 for selecting the plurality of sensor pads 311, that is, the cluster. The selection unit 321_1 may include a plurality of multiplexers (not shown) therein.

In order to perform a touch detection operation in units of clusters, since the plurality of sensor pads 311 included in the selected cluster are simultaneously selected, the plurality of multiplexers may be implemented. For example, when one cluster is configured as N (N is a natural number) sensor pads 311, the minimum number of multiplexers may be N.

However, the number of multiplexers is not limited thereto, and the multiplexers may be implemented with multiple stages. For example, a multiplexers for selecting a sensor pads 311 in one column may be provided, and b multiplexers for selecting b rows among a plurality of rows may be further provided. In this case, “b×a” sensor pads 311 may configure one cluster.

In addition, the multiplexers included in the selection unit 321_1 may be implemented in various exemplary embodiments. In one exemplary embodiment of the present invention, the selection unit 321_1 may simultaneously select at least two sensor pads 311 which are adjacent to each other as one cluster, touch detection operations on corresponding sensor pads 311 may be simultaneously performed, and the response signal may be output as one output signal according to the touch detection operations.

In other words, the selection unit 321_1 may select the signal lines 312 each of which is connected to each of the plurality of sensor pads 311 included in at least one cluster, and electrically connects output terminals of the multiplexers performing the selection, and thus simultaneously outputs an output signal of each cluster to one line by combining the output signals in parallel which are output from the plurality of signal lines 312.

Since the touch detection apparatus according to exemplary embodiments of the present invention performs the touch detection in units of clusters in which each cluster includes a plurality of sensing nodes, an area of a touch detection target may be increased to be proportional to the number of the sensor pads 311 which are simultaneously selected. Since touch capacitance is proportional to the area of the touch detection target, sensitivity may be improved by increasing a difference of the output signals of a case in which a touch occurs and a case in which a touch does not occur in comparison to a case in which a touch does not occur.

Further, an operation of driving each cluster may be performed a number of times that is the same as the number of plurality of sensor pads 311. According to the exemplary embodiment, since the number of clusters tied in different shapes is the same as the number of the sensor pads 311, resolution may be maintained as it is when detecting whether a touch occurs. Since the number of clusters should be the same as the total number of sensor pads 311, at least one sensor pad 311 included in a specific cluster may also be included in at least one other cluster.

Meanwhile, the touch detection unit 321 may include an amplifier and an analog-to-digital converter, and store an output signal in the memory 323 by converting, amplifying, or digitizing the output signal from a cluster that is configured as the plurality of sensor pads 311 which are adjacent to each other.

The touch information processing unit 322 may process data stored in the memory 323, that is, output signals from the clusters, and generate information needed such as whether a touch occurs, a touch area, touch coordinates, etc.

The memory 323 may be configured to store a signal output from the touch detection unit 321, that is, the output signals from the clusters, a reference value for determining whether a touch occurs, or predetermined data.

The control unit 324 may control the touch detection unit 321 and the touch information processing unit 322. The control unit may include a micro control unit (MCU) and perform a predetermined signal processing through firmware.

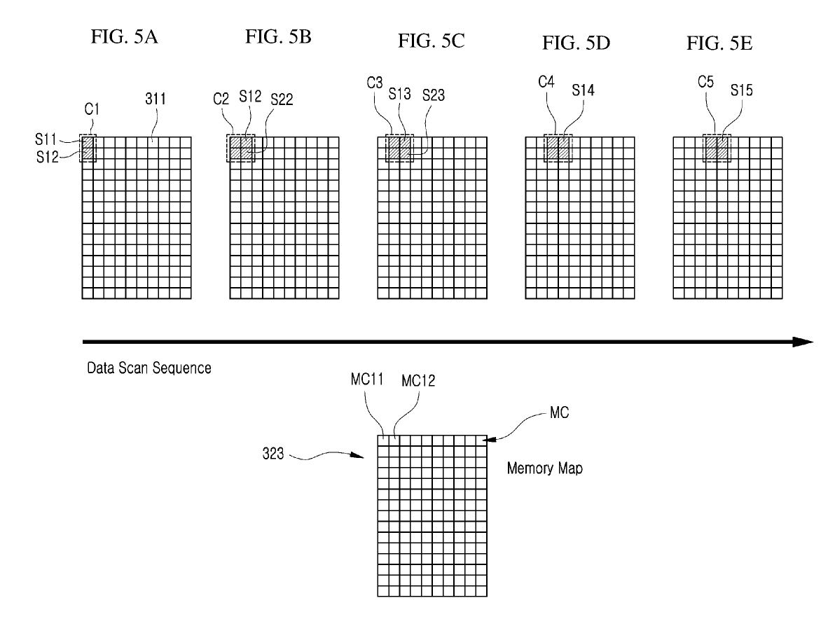

FIGS. 5A-5E are diagrams for describing a touch detection method according to one exemplary embodiment of the present invention.

Referring to FIGS. 5A-5E, a plurality of sensor pads 311 may be arranged in rows and columns. In FIGS. 5A-5E, an example in which the plurality of sensor pads 311 are arranged in a 10×15 matrix form is illustrated, but this is merely one example.

Meanwhile, a memory 323 shown in FIGS. 5A-5E may be configured as a plurality of memory cells MC, and the number of the plurality of memory cells MC may be the same as the number of the plurality of sensor pads 311, and, desirably, the memory 323 may configure a memory map in the same matrix form as the sensor pads 311. In FIGS. 5A-5E, an example in which the memory 323 includes a plurality of memory cells MC configuring a memory map of 10×15 is illustrated.

In FIGS. 5A-5E, an example in which a signal line connected to each sensor pad 311, and a touch detection unit, a touch information processing unit, and a control unit of a driving device are omitted is illustrated.

FIGS. 5A-5E illustrate a sequence of detecting whether a touch has occurred on the sensor pads 311, that is, a scan sequence.

As described above, the plurality of sensor pads 311 which are adjacent to each other may be simultaneously selected as one cluster by a touch detection unit of a driving device.

According to a conventional touch detection method, a scan for detecting whether a touch occurs is performed by sequentially selecting the plurality of sensor pads 311 one by one, but conversely, according to the touch detection method according to one exemplary embodiment of the present invention, a scan for detecting whether a touch occurs is performed by selecting clusters configured as the plurality of sensor pads 311 one by one.

In FIGS. 5B-5E, an example in which four sensor pads 311 configured as “two rows×two columns” configure one cluster is illustrated.

Assume that the sensor pad 311 arranged at a top right among the four sensor pads 311 configuring the cluster is a reference sensor pad of the corresponding cluster. As shown in FIG. 5A, when an initial scan is performed, a first cluster C1 which is based on the sensor pad S11 arranged in a first row and a first column may be selected. Since the sensor pad 311 is not arranged to the left of a sensor pad S11 arranged in the first row and the first column, only two sensor pads S11 and S21 may be included in the first cluster C1.

When the sensor pads S11 and S21 included in the first cluster C1 are simultaneously selected, output signals from the corresponding sensor pads S11 and S21 may be combined, and the combined output signals may be output as one signal for the first cluster. The output signal may be stored in the memory 323 as the output signal from the first cluster C1. Since the output signal is output from the first cluster C1 in which the sensor pad S11 arranged in the first row and the first column is the reference sensor pad, the output signal may be stored in a memory cell MC11 of the first row and the first column, that is, the memory cell MC11 corresponding to the sensor pad S11 which is a reference node of the first cluster C1, in the memory map of the memory 323. The output signal may be obtained after applying a predetermined driving signal to the sensor pads S11 and S21. That is, the output signal may be a response signal obtained by applying the predetermined driving signal to the sensor pads S11 and S21 and combining the output signals from the sensor pads S11 and S21, and thus the combined signals may be output as one signal. In this case, the output signals may be combined in parallel according to one exemplary embodiment, and may be combined in series, in a cumulative manner, or in various manners.

After a scan on the first cluster C1 is completed, a scan may be performed on a second cluster C2 based on a sensor pad S12 arranged in the first row and a second column. Sensor pads S11, S21, and S22 arranged to the left, the bottom left, the bottom of the sensor pad S12 arranged in the first row and the second column may be included in the second cluster C2. A signal output from the second cluster C2 may be stored in a memory cell MC12 of the first row and the second column, that is, the memory cell MC12 corresponding to the sensor pad S12 which is a reference node of the second cluster C2, in the memory map of the memory 323.

In the same manner, scans on a third cluster C3 based on a sensor pad S13 of the first row and a third column, a fourth cluster C4 based on a sensor pad S14 of the first row and a fourth column, and a fifth cluster C5 based on a sensor pad S15 of the first row and a fifth column may also be performed.

Since all of the sensor pads 311 become a reference sensor pad of a cluster one by one, the number of scans may be the same as a case of scanning while sequentially selecting the sensor pads 311 one by one. Accordingly, the number of output signals of the clusters stored in the memory map of the memory 323 may be the same as the case of scanning while sequentially selecting the sensor pads 311 one by one. The touch information processing unit 322 (refer to FIG. 4) may determine a touch generation position based on the output signals of the clusters stored in the memory 323.

Since the signals stored in the memory map of the memory 323 are the output signals from the clusters in which all of the sensor pads 311 become the reference sensor pad one by one, resolution of detecting whether a touch occurs may be maintained as in the case of scanning while sequentially selecting the sensor pads 311 one by one. Meanwhile, since four sensor pads become a unit used for determining whether a touch occurs and a touch capacitance generated between the sensor pad and a touch generation means is four times greater than that of a case in which only one sensor pad becomes a unit used for determining whether a touch occurs, sensitivity of detecting whether a touch occurs may be improved. Here, detecting whether a touch occurs should be understood as a concept including not only detecting a direct touch of a touch generation means on a touch panel in which the sensor pads 311 are formed but also detecting a “hover” which is close to but does not contact the touch panel.

In FIGS. 5B-5E, an example in which four sensor pads 311 configure one cluster is illustrated, but a plurality of other sensor pads 311 may configure one cluster.

For example, an operation of detecting whether a touch occurs may be performed by configuring two, six, or nine sensor pads 311 as one cluster, and resolution can be maintained in every case in which all the sensor pads 311 are used as a reference sensor pad 311 of different clusters.

According to one exemplary embodiment of the present invention, a scan operation may be performed by designating a cluster so that the sensor pads 311 do not overlap before a scan operation in which all of the sensor pads 311 become the reference sensor pad 311 of one cluster one by one. That is, the scan operation may be performed on each cluster by including the plurality of sensor pads 311 in only one cluster. On the other hand, the scan operation may be performed on each of the plurality of clusters by designating a cluster so that the sensor pads 311 included in the clusters do not overlap. Further, the scan operation may be performed on a cluster first based on some of the sensor pads 311 which are arbitrarily extracted.

For example, scan operations shown in FIGS. 5A, 5C, and 5E may be omitted, and a scan operation shown in FIG. 5D may be performed after a scan operation shown in FIG. 5B. When configuring one cluster using four sensor pads 311, the entire scan may be completed using a number of scan operations which is decreased by ¼ in comparison to a case of the touch detection operation being performed by selecting the sensor pads 311 one by one. When a signal related to touch generation is output from at least one cluster while the scan operation is repeatedly performed, the scan operation in which all of the sensor pads 311 become the reference sensor pad 311 of one cluster one by one may be performed according to one exemplary embodiment.

That is, a scan operation speed may be improved before a touch occurs and efficiency of detecting whether a touch has occurred may be improved by the touch detection operation being performed by decreasing the resolution of the touch detection operation and increasing the resolution and performing the touch detection operation when a touch generation signal is detected.

Meanwhile, according to one exemplary embodiment of the present invention, when the touch generation signal is detected in a specific cluster while the scan in units of clusters is performed, the scan operation may be performed by selecting the sensor pads 311 included in the corresponding cluster one by one.

In the case of a “hover” showing a touch effect when a touch generation means approaches a touch pad within a predetermined distance without coming into actual contact therewith, touch capacitances may be generated between the plurality of sensor pads 311 arranged in the vicinity of a position at which the touch occurs and the touch generation means. Accordingly, when the scan in units of clusters is performed, a hover generation signal may be detected in a cluster of a hover generation position.

However, when the touch detection operation is performed on each of the sensor pads 311 included in a corresponding cluster, a non-touch generation signal may be detected on all of the sensor pads 411.

Since the touch capacitance generated between the touch generation means and each of the sensor pads 311 when a hover occurs is smaller than that of a case in which a direct touch occurs and the output signals from the sensor pads 311 configuring the cluster are combined, the hover generation signal may be detected in the cluster unit.

For example, when the hover generation signal is detected in the second cluster C2 shown in FIG. 5B, non-touch generation signals may be detected in the four sensor pads S11, S12, S21, and S22 when the scan is individually performed on each of the sensor pads S11, S12, S21, and S22 included in the corresponding cluster C2.

The touch information processing unit 322 (refer to FIG. 4) detects a hover generation signal only when performing the scan in units of clusters, and an event generated only when the non-touch generation signal is detected for each of the sensor pads S11, S12, S21, and S22 included in the corresponding cluster C2 is determined as hover generation.

According to one exemplary embodiment of the present invention, using the rule described above, the touch detection operation may be individually performed on each of the sensor pads 311 included in the corresponding cluster only when the hover generation signal detected when the scan in units of clusters is performed is a predetermined threshold value or more.

When a hover occurs, since amplitudes of signals generated throughout the entire cluster have to be small in comparison to a case in which a touch occurs on a specific sensor pad 311, a hover may be determined as having occurred in a corresponding cluster when a hover generation signal detected after the scan in units of clusters is performed is less than the threshold voltage, and conversely, since a possibility in which a touch occurs on the specific sensor pad 311 is great when the hover generation signal is the threshold value or more, the touch detection operation may be performed on each of the sensor pads 311 included in the corresponding cluster.

Accordingly, whether a corresponding event has been generated may be determined by a hover or a touch even when using the scan performed in units of clusters, and efficiency in the hover detection operation may be increased since whether a hover has occurred on each sensor pad 311 is determined without the touch detection operation.

Meanwhile, in a case in which a touch occurs using a touch generation means having a small sectional area such as a stylus pen, the touch generation signal is detected only from a specific sensor pad 311 which is in contact with the touch generation means. For example, the touch generation signal may be detected in the second cluster C2 shown in FIG. 5B, and when the touch by the stylus pen actually occurs on the sensor pad S22 arranged in a second row and a second column, the touch generation signal may be detected only from the sensor pad S22 arranged in the second row and the second column and may not be detected from the remaining sensor pads S11, S12, and S21 when a scan is individually performed on each of the sensor pads S11, S12, S21, and S22 included in the second cluster C2.

The touch information processing unit 322 may determine that the touch occurs on the corresponding sensor pad S22 when the hover generation signal is detected when a scan in units of clusters is performed and the touch generation signal is detected on the specific sensor pad S22 among the sensor pads S11, S12, S21, and S22 included in the corresponding cluster C2.

When the scan in units of clusters is performed, a hover may be determined as occurring in the corresponding cluster when an event generation signal is detected from the specific cluster, and a corresponding event is determined as being generated by the touch when the touch generation signal is detected from the specific sensor pad by the touch detection operation being performed on each of the sensor pads included in the corresponding cluster. Conversely, when the non-touch generation signal is detected from the sensor pads included in the corresponding cluster, a corresponding event may be determined as being generated by the hover.

Accordingly, the scan performed in units of clusters may be referred to as the hover detection operation, and the scan on each of the sensor pads included in the corresponding cluster may be referred to as the touch detection operation.

In addition, even when a touch occurs in a dead zone such as a space between sensor pads, the hover generation signal may be detected in a cluster unit that covers a corresponding region. When the touch occurs in the dead zone, the touch generation signal may not be detected when the scan is performed by selecting each sensor pad 311 one by one, and even in this case, a minute touch capacitance may be generated between the touch generation means and adjacent sensor pads 311. The touch capacitances generated on the sensor pads 311 included in the corresponding cluster by the scan being performed on the cluster including the sensor pads 311 generating the minute touch capacitance together with the touch generation means may be added, and when the sum of the added touch capacitances is greater than a predetermined value, the hover generation signal may be detected in the corresponding cluster. That is, according to one exemplary embodiment of the present invention, a touch by a touch generation means having a small sectional area may be detected even in the dead zone.

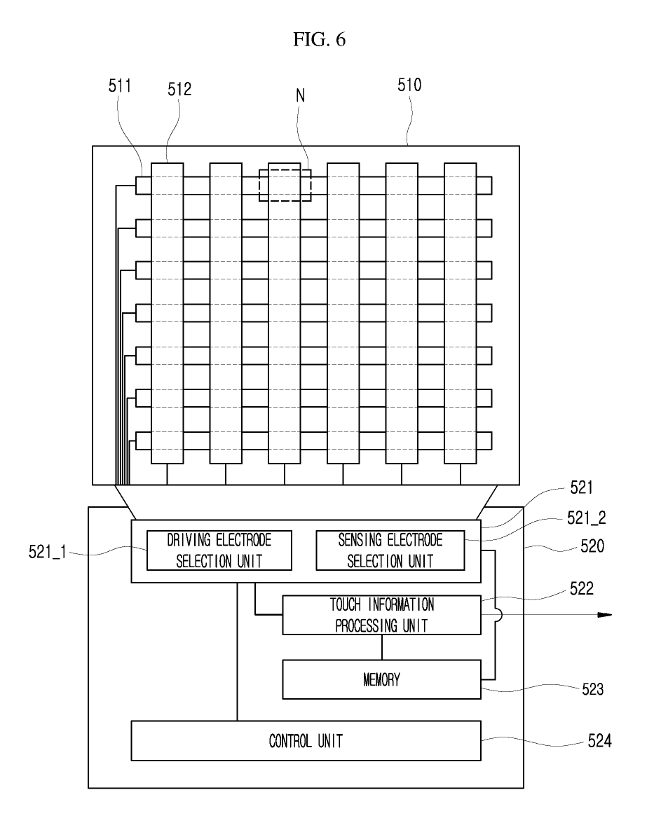

FIG. 6 is a diagram illustrating a configuration of a touch detection apparatus according to another exemplary embodiment of the present invention.

Referring to FIG. 6, the touch detection apparatus may include a touch panel 510 and a driving device 520.

The touch panel 510 may include a plurality of driving electrodes 511, which are arranged in parallel in a first direction, and a plurality of sensing electrodes 512 which are arranged in parallel in a second direction which is perpendicular to the first direction. The driving electrode 511 and the sensing electrode 512 may be electrically insulated and arranged on different layers, and a region in which the driving electrode 511 and the sensing electrode 512 intersect may be referred to as a sensing node N which is a unit used for detecting a touch.

A predetermined driving signal is applied to the driving electrode 511, and a mutual capacitance may be formed between the driving electrode 511 and an adjacent sensing electrode 512 by the predetermined driving signal being applied to the driving electrode 511. When a touch by a touch generation means occurs in a specific sensing node N and the predetermined driving signal is applied to the driving electrode 511 passing through the corresponding sensing node N, a signal different from a case in which a touch does not occur may be output from the sensing electrode 512 passing through the corresponding sensing node N.

Generally, the touch detection operation, that is, the scan operation, is performed on only one sensing node N at a time. That is, whether a touch has occurred may be determined by selecting one driving electrode 511 at a time, applying the predetermined driving signal thereto, and detecting a signal output by selecting the sensing electrodes 512 one by one.

In another exemplary embodiment of the present invention, the scan may be performed in units of clusters in which each cluster includes the plurality of sensing nodes N.

In detail, after simultaneously applying the predetermined driving signal to corresponding driving electrodes 511 by simultaneously selecting the plurality of driving electrodes 511 which are adjacent to each other, output signals may be sequentially detected by selecting the sensing electrodes 512 one by one. Further, when the predetermined driving signal is applied to at least one driving electrode 511, output signals from the corresponding sensing electrodes 512 may be received by simultaneously selecting the plurality of sensing electrodes 512. The output signals from the plurality of sensing electrodes 512 may be combined in parallel, and output signals from the corresponding cluster may be output as one value. Meanwhile, in a state in which the predetermined driving signal is simultaneously applied to the plurality of driving electrodes 511 which are adjacent to each other, a plurality of sensing electrodes 512 which are adjacent to each other may be simultaneously selected, and output signals may be simultaneously received from the selected sensing electrodes 512.

The touch detection unit 521 of the driving device 520 may include a driving electrode selection unit 521_1 and a sensing electrode selection unit 521_2.

Each of the driving electrode selection unit 521_1 and the sensing electrode selection unit 521_2 may include a plurality of multiplexers (not shown). Since one multiplexer selects one electrode, at least two multiplexers may be included in each of the driving electrode selection unit 521_1 and the sensing electrode selection unit 521_2. In order to select A driving electrodes 511 and B sensing electrodes 512, the minimum number of multiplexers which should be included in the driving electrode selection unit 521_1 and the sensing electrode selection unit 521_2 may respectively be A and B. However, the number of the multiplexers is not limited thereto, and the multiplexers may be implemented with multiple stages.

In the exemplary embodiment shown in FIG. 6, since the scan is performed one time on the cluster including the plurality of sensing nodes N, the sensitivity of detecting whether a touch occurs may be improved for the same reason as described with reference to FIGS. 4 and 5A-5E. Further, even when the scan is performed using the plurality of sensing nodes N as one cluster, the resolution may be maintained to be the same as the case in which the scan is sequentially performed by selecting the sensing nodes N one by one since the scan is performed by forming the same number of clusters as the number of the sensing nodes N using another combination.

Since the other components excluding the touch detection unit 521 included in the driving device 520, that is, the touch information processing unit 522, the memory 523, and the control unit 524 are the same as those described with reference to FIG. 4, a description thereof will be omitted here.

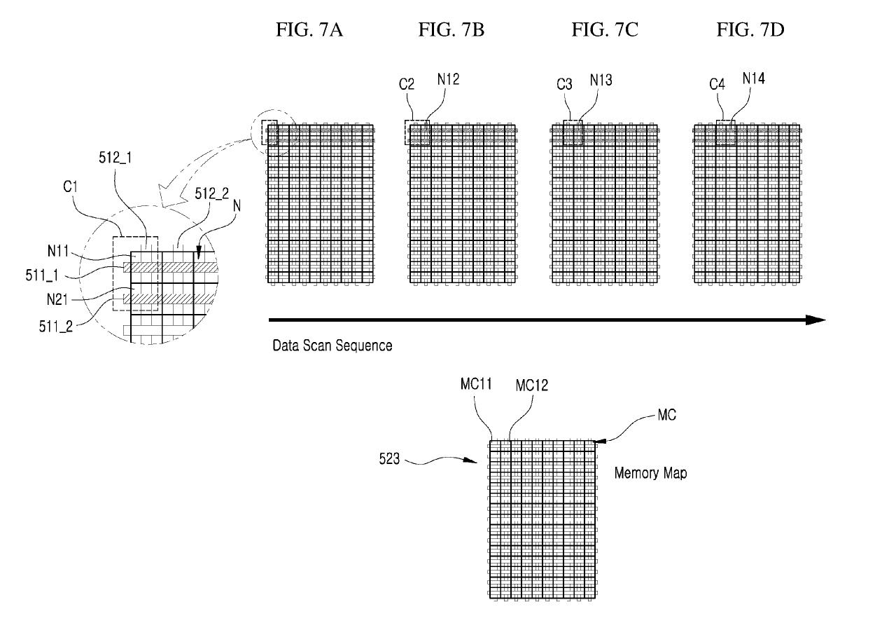

FIGS. 7A-7D are diagrams for describing a touch detection method of the touch detection apparatus shown in FIG. 6.

Referring to FIGS. 7A-7D, 15 driving electrodes 511 and 10 sensing electrodes 512 may be arranged to intersect each other, and thus a total of 10×15 sensing nodes N may be formed. Meanwhile, the memory 523 may be configured as a memory map including the same number of memory cells MC as the number of the sensing nodes N.

FIGS. 7A-7D illustrate a sequence for detecting whether a touch occurs in each of the sensing nodes N, that is, a scan sequence.

FIGS. 7A-7D illustrate an example in which four sensing nodes N which are adjacent to each other configure one cluster, but any example in which adjacent sensing nodes N are selected and configured as a cluster may be included in the scope of the present invention.

When assuming that a sensing node N located at the top right among the sensing nodes N configuring the cluster is a reference sensing node N of the corresponding cluster, a first cluster C1 may be selected based on a sensing node N11 arranged in a first row and a first column when an initial scan is performed as shown in FIG. 7A. Since the sensing node N is not formed to the left of the sensing node N11 arranged in the first row and the first column, only two sensing nodes N11 and N21 may be included in the first cluster C1.

A scan method performed on the sensing nodes N11 and N21 included in the first cluster C1 is as follows. The driving electrodes 511_1 and 511_2 passing through the corresponding sensing nodes N11 and N21 may be selected, a predetermined driving signal may be simultaneously applied thereto, and an output signal may be received from a sensing electrode 512_1 passing through the corresponding sensing nodes N11 and N21. The received output signal may be stored in the memory cell MC11 located in the first row and the first column in the memory map of the memory 523.

A scan may be performed on a second cluster C2 using a sensing node N12 arranged in the first row and a second column as a reference sensing node after the scan on the first cluster C1 is completed. Sensing nodes N11, N21 and N22 arranged to the left, the bottom left, and the bottom of on the sensing node N12 arranged in the first row and the second column may be included in the second cluster C2.

In a state in which the predetermined driving signal is applied to the driving electrodes 511_1 and 512_2 passing through the four sensing nodes N11, N12, N21 and N22, output signals may be simultaneously received from the sensing electrodes 512_1 and 512_2 passing through the corresponding sensing nodes N11, N12, N21 and N22. The output signals from the two sensing electrodes 512_1 and 512_2 may be combined in parallel and be output through one line, and the output signal may be stored in a memory cell MC12 arranged in the first row and a second column in the memory map of the memory 523.

In the same manner, scans may also be performed on a third cluster C3 using the sensing node N13 arranged in the first row and a third column as a reference sensing node, and a fourth cluster C4 using the sensing node N14 arranged in the first row and a fourth column as a reference sensing node.

Since all of the sensing nodes N are used as the reference sensing node of the cluster one by one, the number of scans may be the same as a case of performing the scan while sequentially selecting the sensing nodes N one by one. Accordingly, resolution of detecting whether a touch occurs may be maintained to be the same as a case of performing the scan while sequentially selecting the sensing nodes N one by one. Meanwhile, since four sensing nodes N are a unit for performing the scan, a change of mutual capacitance having an effect on the touch generation signal may be increased by four times in comparison to a case of using one sensing node N as the unit for performing the scan, and thus the sensitivity of detecting whether a touch occurs may be improved.

As described with reference to FIGS. 5A-5E, the operation of performing the scan on the plurality of clusters respectively in which the sensing nodes N configuring each of the plurality of clusters do not overlap, that is, each of the plurality of sensing nodes N is included in only one cluster, may be performed before the scan operation in which all of the sensing nodes N function as the reference sensing node N of the cluster one by one is performed.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent

1. A touch detection method comprising:
(a) performing a hover detection operation on each of a plurality of clusters in which each of the clusters is configured as any one of a plurality of sensing nodes and at least one sensing node adjacent thereto; and
(b) detecting whether a touch occurs on the sensing nodes included in a corresponding cluster based on a result of the hover detection operation.

2. The touch detection method of claim 1, wherein the step (a) comprises:
performing the hover detection operation on each of the plurality of clusters in which the sensing nodes included in each of the plurality of clusters do not overlap;
setting any one of the plurality of sensing nodes as a reference node, and designating the plurality of clusters in which each cluster is configured as the reference node and at least one sensing node adjacent to the reference node; and
when the hover detection signal is detected in an arbitrary cluster, performing the hover detection operation on each of the clusters by setting the plurality of clusters so that each of the plurality of sensing nodes is used as the reference node once.

3. The touch detection method of claim 1, wherein the step (b) comprises performing the touch detection operation on each sensing node included in a cluster in which a hover generation signal is detected.

4. The touch detection method of claim 3, wherein the step (b) comprises performing the touch detection operation on each of the sensing nodes only when the hover generation signal has a threshold value or more.

5. The touch detection method of claim 4, further comprising determining that a touch has occurred on the corresponding sensing node when a touch generation signal is detected in a specific sensing node according to a result obtained by performing the touch detection operation.

6. The touch detection method of claim 1, wherein the step (a) comprises:
obtaining an output signal of each of the clusters by simultaneously applying a predetermined driving signal to the plurality of sensing nodes configuring each of the clusters; and
combining output signals from the sensing electrodes passing through the sensing nodes as a response to the predetermined driving signal.

7. The touch detection method of claim 1, wherein the step (a) comprises:
simultaneously applying the predetermined driving signal to at least one driving electrode passing through the plurality of sensing nodes configuring each of the clusters; and
obtaining an output signal of each of the clusters by combining output signals from at least one sensing electrode passing through the plurality of sensing nodes configuring each of the clusters.

8. A touch detection method comprising:
selecting a first cluster configured as a plurality of sensing nodes;
obtaining a first output signal of the first cluster by combining signals output as a result of a touch detection operation performed on the sensing nodes included in the first cluster;
selecting a second cluster including some of the sensing nodes of the first cluster and configured as a plurality of sensing nodes; and
obtaining a second output signal of the second cluster.

9. The touch detection method of claim 8, wherein:
the first cluster and the second cluster respectively include a first reference node and a second reference node; and
a memory is configured to store the output signals of the first cluster and the second cluster in correspondence to the first reference node and the second reference node.

10. The touch detection method of claim 9, wherein the first reference node and the second reference node are arranged to be adjacent to each other.

11. A touch detection apparatus comprising:
a touch panel including a plurality of sensing nodes; and
a touch detection unit configured to perform a hover detection operation on each of a plurality of clusters in which each of the clusters is configured as any of the plurality of sensing nodes and at least one sensing node adjacent thereto, one of the sensing nodes in each of the cluster being set as a reference node, each of the clusters is being configured as the reference node and at least one sensing nodes being adjacent to the reference node, and to detect whether a touch occurs on the sensing nodes included in the specific cluster based on a result of the hover detection operation.
